(19) United States
(12) Patent Application Publication
(10) Pub. No.: US 2006/0188628 A1
(43) Pub. Date: Aug. 24, 2006

(54) Blended sugar sweetener

(76) Inventors: Joseph M. Coffield, Richmond Hill, GA (US); John E. Curry, Savannah, GA (US); Steven M. Scott, Jupiter, FL (US)

Correspondence Address: EDWARDS & ANGELL, LLP, P.O. BOX 55874, BOSTON, MA, 02205, US

(21) Appl. No.: 11/218,199

(22) Filed: Sep. 1, 2005

Related U.S. Application Data
(63) Continuation-in-part of application No. 11/051,880, filed on Feb. 4, 2005.
(63) Continuation-in-part of application No. 11/051,181, filed on Feb. 7, 2005.

(51) Int. Cl. A23L 1/236

(52) U.S. Cl. 426/548

(57) ABSTRACT

The present invention is directed to a blended sweetener and method of making the same composed of acesulfame potassium, sucrose and Neotame, and a binding agent which provides a sweetness equivalent to sucrose with less calories and less carbohydrates than sucrose on an equivalent basis.

This application is a continuation-in-part of U.S. patent application Ser. No. 11/051,880, filed Feb. 4, 2005, and U.S. patent application Ser. No. 11/051,181, filed Feb. 4, 2005, the entire contents of each herein incorporated by reference in their entirety.

### BACKGROUND OF THE INVENTION

1. Field of the Invention

The present invention relates to novel blended sugar compositions; in particular, to low-calorie, low-carbohydrate sweetener compositions that have significantly more sweetness than sucrose.

2. Description of Background Art

The sweet taste of sugars has contributed to the popularity of natural foods such as fruits and prepared foods. In the United States particularly, the sweet tooth of the American public has led to increasing use of natural sugars and artificial sweeteners in commercial food products. While the nutritional importance of fats, proteins and carbohydrates in the diet is well-recognized, the sweet taste of sugar is a source of pleasure beyond mere nutrition to most individuals, and may account in part for increased consumption of high calorie desserts and sweet-tasting food products.

Sweeteners, whether natural or artificial, have become ubiquitous in a wide array of food products and particularly in prepared foods. Availability of convenience-oriented foods has contributed to increased consumption of sweeteners and sweet-tasting foods, leading to increased calorie consumption and a notable rise in obesity in the general population, particularly in the United States. Attempts to reduce the calorie content of foods without sacrificing the sweet taste has led to a high demand for diet foods that are sweetened with low or no calorie artificial or high intensity sweeteners such as saccharin and aspartame.

Many artificial sweeteners have a sweetening power that is significantly greater than that of natural sugars. Therefore, these artificial sweeteners are advantageously used for the sweetening of food, beverages, animal feed, and even in oral pharmaceutical preparations to hide the unpleasant taste of drugs. Sugars have been used in cosmetics, but the purpose is related to skin conditioning and hydration and clearly not to appeal to taste.

A distinct disadvantage of many currently used artificial sweeteners their more or less strong aftertaste, especially in higher concentrations. The flavor quality of the sweetness in these artificial products frequently differs from that of sucrose and may not be acceptable to those accustomed to the taste of sucrose.

Sucrose serves as a standard for the evaluation of the sweetness, despite the existence of other natural sugars such as fructose, which are relatively sweeter. In determining “sweetness” sucrose is set at an arbitrary standard value of 100 so that other sweet substances can be numerically compared. Fructose, for example, has a value of 140 on this relative sweetness scale while other natural sugars such as glucose, galactose, maltose and lactose have relative values of 70-80, 35, 30-50 and 20 respectively. Sucrose may have been selected as the standard simply because it is the best known sugar, having been used and isolated from sugar cane and sugar beets by populations throughout the world over a long period of time.

A notable disadvantage of “high intensity” sweeteners is that often they do not have the appearance of sugar, and may not taste or act like sugar if used as a sugar substitute in recipes, despite being “sweeter” than sucrose. Other sweeteners, such as cyclamate, intended for use by consumers as a sugar substitute, provide fewer calories and less carbohydrate, but do not possess a sweetness power or taste equivalent to sucrose.

The sweetener ratio of volume to sweetness power for some sweeteners differs significantly from that of sucrose. Since most people use the sweetness of sucrose as a basis for comparison, especially when adding sugars to solid food or drinks, use of sweeteners requires trial and error experimentation by consumers to first determine the relative equivalency between the sweetener and sucrose.

Accordingly, there remains a need for sweeteners containing fewer calories than sugar. There also exists a need for sweeteners that impart a taste that closely mimics the taste of sucrose.

### BRIEF SUMMARY OF THE INVENTION

The present invention addresses some of the disadvantages in currently available sweeteners, by providing a blended sugar substitute that has at least twice the sweetness of sucrose compared on a volume (v/v) basis. An important feature of the invention is that the new sugar substitute does not require consumer experimentation to determine a selected amount of sweetness; rather a selected measured amount can be formulated to have an easily understandable sweetness value in comparison with sucrose.

The present invention thus improves upon and solves some of the problems associated with the prior art by providing, among other things, a blended sweetener that meets several of the needs discussed above.

An attractive feature of the invention is the marketability not only to the consumer but also to the supplier. The consumer will have a product that tastes, looks and feels like sucrose, but can be formulated for use as an easily understood equivalent to sucrose. Thus in recipes where normally one cup of sugar would be used, the consumer can readily use an indicated equivalent, preferably one-half the amount of blended sweetener compared to the amount of sucrose normally used.

A supplier or manufacturer can provide equivalent sucrose bulk or packaged amounts of the disclosed sweetener blends using less bulk material and smaller packages. Less volume of sweetener product can be used in food manufacturing, saving space but importantly adding sweetness to dietary products. Wider consumer acceptance of lower calorie foods is expected to have a positive effect on sales.

In one aspect, the present invention is directed to a blended sweetener that provides twice the sweetness power of sugar on about the same volumetric basis, but with fewer calories. It is also possible to reduce carbohydrate content in some food preparation, further reducing caloric content, because sweetness in some foods is due to breakdown of starches in the oral cavity by enzymes in the saliva. Additionally, the blended sweetener of the present invention has no significantly unpleasant aftertaste and imparts a sucrose-like taste. This is quite important in dessert recipes and in bakery products. A sucrose or sugar flavor is particularly important in popular soft drinks, as well as tea and coffee.

The present invention also provides a method of substituting a novel sugar substitute for sucrose while imparting a sweet taste into food, beverages, recipes or other items that might benefit from having a sweet taste. The present invention thus includes food, beverages, recipes or other items containing a blended sweetener formed in accordance with the present invention as substitute for sugar.

In one embodiment, the blended sweetener of the present invention includes a first sweetener, a second sweetener having a higher sweetness power than the first sweetener, sucrose, and a binding agent. The first sweetener, second sweetener, sugar, and binding agent are combined in amounts or ratios such that the resulting sweetener composition yields an overall sweetness power about twice that of sucrose on a volumetric basis, yet contains less calories and less carbohydrates compared with equivalent amounts of sucrose. Preferably, a blended sweetener of the present invention contains about half the calories and half the carbohydrates comparatively with an equivalent amount of sucrose.

In a preferred exemplary embodiment, a blended sweetener fabricated in accordance with the present invention comprises acesulfame potassium, sucrose and Neotame (i.e., N-[N-(3,3-dimethylbutyl)-L-aspartyl]-L-phenylalanine 1-methyl ester—available from The Nutrasweet Company), among other things. The aforementioned components are included in amounts so that the blend preferably results in a sweetener having a sweetness power twice that of sucrose on a volumetric basis yet contains less calories and less carbohydrates by comparison with equivalent amounts of sucrose. In preferred embodiments, a blended sweetener of the present invention contains about half the calories and half the carbohydrates comparatively with an equivalent amount of sucrose.

The disclosed formulations for blended sugar sweeteners can be modified, not only with flavor enhancers, but particularly with colors, such as botanical colorants. While not wishing to be limited to any particular color, it is well known that pink is particularly attractive to some children so that sweetened products such as decorated cookies, colored drinks, cakes and ice cream can be prepared with the disclosed blended sweeteners.

These and other aspects of the present invention will become more readily apparent to those having ordinary skill in the art from the following detailed description of the invention.

### DETAILED DESCRIPTION OF THE INVENTION

The present invention provides a blended sweetener product with the taste and flavor of sucrose but with the ability to deliver the same sweetness as sucrose by using half the amount of sucrose. The additional advantages of this product include fewer calories for the same sweetness effect, expected high consumer acceptance and significant savings in packaging and shipping costs.

Reference is now made to the following detailed description, which has been provided to illustrate preferred and exemplary embodiments of the present invention, but is not intended to limit the scope of the present invention.

The present invention thus provides a blended sweetener composition, which includes at least one high intensity sweetener with a binding agent and sugar. The blended sweetener includes at least one high intensity sweetener, a binding agent and a sugar that is equivalent to sucrose in sweetness but contains less calories and less carbohydrates. Preferably the blended sweetener is equivalent to twice the sweetness of sucrose and contains about half the calories and carbohydrates of sugar by volume.

Preferably, the sweetener of the present invention includes a first sweetener, a second sweetener, a sugar, and a binding agent, wherein the second sweetener has a higher sweetness power than the first sweetener, and more preferably, the second sweetener has a sweetness power which is of a substantial magnitude (e.g., at least 10 times) greater than the first sweetener.

The first and second sweeteners may be chosen based on compatibility or the potential for a beneficial synergistic effect. The first and second sweeteners selected provide a high sweetness quality without a lingering or bitter aftertaste. Preferably, the first sweetener has the characteristic of a sweetness profile, which evolves rapidly and fades slowly, while the second sweetener provides the high sweetness power behind or underneath the lasting taste of the first sweetener.

In a non-limiting embodiment, a blended sweetener in accordance with the present invention includes a first sweetener, which is at least 100 times sweeter than sugar, and a second sweetener at least 2000 times sweeter than sugar, sugar, and a binding agent in ratios that preferably result in a sweetness power about twice the sweetness of sugar with about half the net carbohydrates and calories as sugar by equivalent volume. The second sweetener preferably has a sweetness at least 40 times greater than the sweetness of the first sweetener.

In a particularly preferred embodiment, the blended sweetener includes acesulfame potassium having a sweetness approximately 200 times that of sugar, Neotame having a sweetness approximately 8000 times that of sugar, sugar, and a binding agent.

Preferably, the binding agent of the present invention has low or almost no sweetness, and has a substantially bland or neutral taste. Preferably, the density of the binding agent ranges from about 28 lb/ft³ to about 38 lb/ft³ (i.e., from about 448.5 kg/m³ to about 609 kg/m³). It is also preferable to use a binding agent that is white in color, easily digestible, cold-water soluble, and contains little or no significant quantities of fat, protein or fiber.

Preferably, the blended sweetener of the present invention includes acesulfame potassium in a range from about 0.32% to about 0.39%, Neotame in a range from about 0.003% to about 0.005%, sugar in a range from about 99.36% to about 99.52%, and a binding agent in a range from about 0.19% to about 0.23%. In a highly preferred embodiment, the blended sweetener of the present invention includes acesulfame potassium at about 0.35%, Neotame at about 0.004%, sugar at about 99.44% and a binding agent about 0.21% by weight.

In preferred embodiments, the binding agent may be maltodextrin or dextrose. The maltodextrin or dextrose binding agent may have a density ranging from about 28 lb/ft³ to about 38 lb/ft³ (i.e., from about 448.5 kg/m³ to about 609 kg/m³).

An exemplary method of making a blended sweetener of the present invention includes mixing the binding agent with the second sweetener having the highest sweetness power, adding the first sweetener with the lower sweetness power, sugar to the mixture of the binding agent and second sweetener to build the blend. Preferably, the method of the present invention is carried out with substantially dry ingredients.

The volumetric and sweetness equivalency of the blended sweetener of the present invention to that of sugar permits it to be used as a sugar substitute in a variety of applications without loss in sweetness or compromised integrity taste. Moreover, the blended sweetener of the present invention has half the calories and half the carbohydrates of sugar on an equivalent basis. Preferably, a sweetener according to the present invention also has the consistency and appearance of sugar, and generally has sugar-like characteristics and qualities when used in applications as a sugar substitute.

Although exemplary and preferred aspects and embodiments of the present invention have been described with a full set of features, it is to be understood that the disclosed blended sweetener and method of making the same may be practiced successfully without the incorporation of each of those features. Thus, it is to be further understood that modifications and variations may be utilized without departure from the spirit and scope of this inventive blended sweetener and method of making the same, as those skilled in the art will readily understand. Such modifications and variations are considered to be within the purview and scope of the appended claims and their equivalents.

### EXAMPLES

The following examples are provided as illustrations of the invention and are in no way to be considered limiting.

### Example 1. Preparation of a Blended Sugar Substitute.

A blended sugar substitute may be prepared by mixing the following dry ingredients shown in Table 1.

TABLE 1

| Ingredient | % (w/w) |
|---|---|
| Acesulfame potassium | 0.35 |
| Neotame | 0.0004 |
| Dextrose | 0.21 |
| Sucrose | 99.44 |

Example 2.

What is claimed is:

1. A blended sweetener comprising:
a) a first sweetener;
b) a second sweetener;
c) sucrose; and
d) a binding agent,
wherein the second sweetener has a higher sweetness power than the first sweetener, and the first sweetener, second sweetener, sucrose, and binding agent are included in a ratio such that composition has an overall sweetness power at least twice that of the same volume of sucrose.

2. A blended sweetener as recited in claim 1, wherein the second sweetener has a sweetness power which is at least 10 times greater than the first sweetener.

3. A blended sweetener as recited in claim 1, wherein the first and second sweeteners are chosen to have the optimal synergistic effect to provide a sweetness quality without a lingering or bitter aftertaste.

4. A blended sweetener as recited in claim 1, wherein the first sweetener has a sweetness profile that evolves rapidly and fades slowly.

5. A blended sweetener as recited in claim 1, wherein the second sweetener is Neotame.

6. A blended sweetener as recited in claim 1, wherein the first sweetener is acesulfame potassium.

7. A blended sweetener as recited in claim 1, wherein the binding agent has a density of about 448.5 kg/m³ to about 609 kg/m³.

8. A blended sweetener as recited in claim 1, wherein the composition contains fewer calories and carbohydrates than sucrose on a volumetric basis.

9. A blended sweetener as recited in claim 1, wherein the composition contains about half the calories and about half the carbohydrates than sucrose on an equivalent basis.

10. A blended sweetener comprising:
a) Neotame;
b) acesulfame potassium;
c) sucrose; and
d) a binding agent,
wherein the Neotame, acesulfame potassium, sucrose, and binding agent are included in a ratio such that the composition has an overall sweetness power equivalent to about twice that of the same volume of sucrose.

11. A blended sweetener as recited in claim 10, wherein the binding agent is dextrose or maltodextrin.

12. The blended sweetener of claim 10, wherein the binding agent is dextrose having a density of about 448.5 kg/m³ to about 609 kg/m³

13. A blended sweetener as recited in claim 10, wherein the binding agent is maltodextrin having a density of about 448.5 kg/m³ to about 609 kg/m³.

14. A blended sweetener as recited in claim 10, wherein the amount of Neotame ranges from about 0.003% to about 0.005% by weight.

15. A blended sweetener as recited in claim 10, wherein the amount of acesulfame potassium ranges from about 0.32% to about 0.39% by weight.

16. A blended sweetener as recited in claim 10, wherein the amount of sucrose ranges from about 99.36% to about 99.52%.

17. A blended sweetener as recited in claim 10, wherein the binding agent by weight is about 0.21%, the amount of acesulfame potassium by weight is about 0.35%, the amount of Neotame by weight is about 0.004%, and the amount of sucrose by weight is about 99.44%.

18. A packaged product for use as a sweetening agent, comprising the blended sweetener of claim 17 and instructions for use equivalent to sucrose.

19. A blended sweetener as recited in claim 10, wherein the composition has fewer calories and carbohydrates than sucrose on a volumetric basis.

20. A blended sweetener as recited in claim 10, wherein the composition has about half the calories and about half the carbohydrates than sucrose on an equivalent basis.
